(19) United States
(12) Patent Application Publication
(10) Pub. No.: US 2025/0373025 A1
(43) Pub. Date: Dec. 4, 2025

(54) STABILITY ENHANCEMENT CONTROL SYSTEMS FOR INVERTER-BASED TECHNOLOGIES

(71) Applicant: University of South Florida, Tampa, FL (US)

(72) Inventors: Lingling Fan, Tampa, FL (US); Zhixin Miao, Tampa, FL (US)

(21) Appl. No.: 19/225,651

(22) Filed: Jun. 2, 2025

Related U.S. Application Data
(60) Provisional application No. 63/654,314, filed on May 31, 2024.

(51) Int. Cl. H02J 3/46; H02J 3/38; H02M 7/5387

(52) U.S. Cl. CPC H02J 3/46; H02J 3/381; H02M 7/53875

(57) ABSTRACT

An example supplementary control for existing inverter control systems uses the PCC voltage as an input and outputs a signal to modulate the q-axis current order. The supplementary control can mitigate low-frequency oscillations in voltage through reactive current regulation.

### CROSS-REFERENCE TO RELATED APPLICATIONS

This application claims the benefit of U.S. provisional patent application No. 63/654,314 filed on May 31, 2024, and titled “STABILITY ENHANCEMENT CONTROL TECHNOLOGY FOR INVERTER-BASED RESOURCES,” the disclosure of which is expressly incorporated herein by reference in its entirety.

### GOVERNMENT SUPPORT

This invention was made with government support under Grant No. DE-EE0008771 awarded by the Department of Energy. The government has certain rights in the invention.

### BACKGROUND

Inverter-based resources (IBRs) include photovoltaic inverters, wind turbine generators, and battery storage systems. IBRs are deployed in modern power grids using power electronic converters and can deliver both active and reactive power. In a weak grid condition where the grid short-circuit strength is low and/or the grid impedance is high, the operation of IBRs can be complicated. Improvements to systems and methods of controlling IBRs, including systems with many IBRs, can improve the operation and management of the power grid.

### SUMMARY

In some aspects, implementations of the present disclosure include a grid control system including: an inverter coupled to a point of common coupling (PCC); and a controller configured to receive a voltage feedback from the point of common coupling and regulate a q-axis current order of the inverter.

In some aspects, implementations of the present disclosure include a system, further including a high-pass filter configured to filter the voltage feedback from the point of common coupling, wherein the high-pass filter configured is to attenuate low-frequency oscillations.

In some aspects, implementations of the present disclosure include a system, wherein the controller is configured to control a q-axis current of the inverter.

In some aspects, implementations of the present disclosure include a system, wherein the controller is configured to perform coordinated reactive current control of the inverter.

In some aspects, implementations of the present disclosure include a system, wherein the PCC couples one or more inverters.

In some aspects, implementations of the present disclosure include a system, wherein the inverter is configured as a grid-forming inverter.

In some aspects, implementations of the present disclosure include a system, wherein the inverter is configured as a grid-following inverter.

In some aspects, implementations of the present disclosure include a computer-implemented method of controlling an inverter, including: receiving a voltage feedback from a point of common coupling (PCC); and outputting a signal to regulate a q-axis current order of the inverter.

In some aspects, implementations of the present disclosure include a computer-implemented method, further including high-pass filtering the voltage feedback from the point of common coupling, wherein the high-pass filtering configured is to attenuate low-frequency oscillations.

In some aspects, implementations of the present disclosure include a computer-implemented method, further including controlling a q-axis current of the inverter.

In some aspects, implementations of the present disclosure include a computer-implemented method, further including performing coordinated reactive current control of the inverter.

In some aspects, implementations of the present disclosure include a computer-implemented method, wherein the PCC couples one or more inverters.

In some aspects, implementations of the present disclosure include a computer-implemented method, wherein the one or more inverters each are configured as part of an inverter-based resource.

In some aspects, implementations of the present disclosure include a computer-implemented method, wherein the inverter is configured as a grid-forming inverter.

In some aspects, implementations of the present disclosure include a computer-implemented method, wherein the inverter is configured as a grid-following inverter.

In some aspects, implementations of the present disclosure include a non-transitory computer-readable medium having instructions stored therein, wherein execution of the instructions by a processor, causes the processor to: receive a voltage feedback from a point of common coupling; and output a signal to regulate q-axis current orders of an inverter.

In some aspects, implementations of the present disclosure include a non-transitory computer-readable medium, having further instructions stored thereon that, when executed by the processor, cause the processor to high-pass filter the voltage feedback from the point of common coupling, wherein the high-pass filtering configured is to attenuate low-frequency oscillations.

In some aspects, implementations of the present disclosure include a non-transitory computer-readable medium, having further instructions stored thereon that, when executed by the processor, cause the processor to control a q-axis current of the inverter.

In some aspects, implementations of the present disclosure include a non-transitory computer-readable medium, having further instructions stored thereon that, when executed by the processor, cause the processor to perform coordinated reactive current control of the inverter.

In some aspects, implementations of the present disclosure include a non-transitory computer-readable medium, wherein the inverter is configured as a grid-following inverter.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates a two-IBR test-bed circuit topology, according to an example implementation of the present disclosure.

FIGS. 2A-2C illustrate control structures for three example test-bed topologies, according to an example implementation of the present disclosure.

FIG. 3 illustrates a schematic representation of a two-IBR system, according to an example implementation of the present disclosure.

FIG. 4 illustrates a Bode diagram of the 13-Hz PLL's transfer function GPLL,

FIG. 5 illustrates a system block diagram of a system for inverter-based resource (IBR) control, according to implementations of the present disclosure.

FIG. 6 illustrates time-domain simulation results, according to a study of an example implementation of the present disclosure.

FIG. 7 illustrates a bode diagram of a transfer function which imitates the behavior of a low-pass filter where X_{g}=1.0 p.u. and τ=0.1 s.

FIG. 8 illustrates time-domain results demonstrating the effects of an example implementation of the stability controller in mitigation of weak-grid oscillations, according to a study of an example implementation of the present disclosure.

FIG. 9 illustrates a bode diagram of an example open loop system showing the transfer function of a high-pass filter controller enabling a stable system at 7 Hz, according to a study of an example implementation of the present disclosure.

FIG. 10A illustrates voltage feedback control for Testbed-0, according to a study of an example implementation of the present disclosure.

FIG. 10B illustrates voltage feedback control for Testbed-1, according to a study of an example implementation of the present disclosure.

FIG. 10C illustrates voltage feedback control for Testbed-2, according to a study of an example implementation of the present disclosure.

FIG. 11A illustrates results of a small disturbance test for Testbed-0 including response with and without a high-pass filter stability controller, according to a study of an example implementation of the present disclosure.

FIG. 11B illustrates results of a small disturbance test for Testbed-1 including response with and without a high-pass filter stability controller, according to a study of an example implementation of the present disclosure.

FIG. 11C illustrates results of a small disturbance test for Testbed-2 including response with and without a high-pass filter stability controller, according to a study of an example implementation of the present disclosure.

FIG. 12A illustrates results of a small disturbance test for Testbed-0 including time-domain responses of real power and reactive power, according to a study of an example implementation of the present disclosure.

FIG. 12B illustrates results of a small disturbance test for Testbed-0 including time-domain responses of real power and reactive power, according to a study of an example implementation of the present disclosure.

FIG. 12C illustrates results of a small disturbance test for Testbed-0 including time-domain responses of real power and reactive power, according to a study of an example implementation of the present disclosure.

FIG. 13A illustrates results of a large disturbance (line trip) test for Testbed-0, according to a study of an example implementation of the present disclosure.

FIG. 13B illustrates results of a large disturbance (line trip) test for Testbed-1, according to a study of an example implementation of the present disclosure.

FIG. 13C illustrates results of a large disturbance (line trip) test for Testbed-2, according to a study of an example implementation of the present disclosure.

FIG. 14 illustrates a system topology of an example grid-connected grid forming converter,

FIG. 15 illustrates time-domain responses of real power P, reactive power Q, V_{PCC}, frequency and PLL angle Δθ showing increased power transfer capability using the example implementation of the present disclosure.

FIG. 16 illustrates a laboratory-scale hardware testbed for experimental validation, according to a study of an example implementation of the present disclosure.

FIG. 17A illustrates time domain responses of an example implementation of a stability controller mitigating 4 Hz oscillations, according to a study of an example implementation of the present disclosure.

FIG. 17B illustrates improved power transfer capabilities of an example implementation of the present disclosure.

FIG. 18A illustrates parameters of example testbeds used in a study of an example implementation of the present disclosure.

FIG. 18B illustrates example feedback control parameters used in a study of an example implementation of the present disclosure.

FIG. 18C illustrates example parameters used in a study of an example implementation of the present disclosure.

FIG. 19 illustrates a method for IBR control, according to implementations of the present disclosure.

FIG. 20 is an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for coordinating two inverter-based resources, it will become evident to those skilled in the art that the implementations are not limited thereto, but are applicable for any number of inverter-based resources. As used herein, the terms IBR-1 and IBR-2 therefore can refer to not just a single inverter-based resource, but also to two groups of inverter-based resources, where each group can have any number of inverter-based resources that are controlled in common.

Inverter-based resources (IBRs) are commonly deployed in power grids, but existing methods of controlling IBRs focus on the control of individual IBRs. The control of individual IBRs can fail, for example in weak-grid conditions which can cause oscillations. Implementations of the present disclosure overcome limitations of existing control systems and methods that control individual IBRs by including control systems and methods adapted to multiple IBRs.

Implementations of the present disclosure include systems and methods for coordination and control of one or more inverter-based resources (IBRs) operating in weak grids. The example implementations described herein can improve the stability margin close to the steady-state power transfer limit. The implementations described herein can achieve further stability enhancement even with well-designed individual IBR's control. The example implementation can implement these improvements by using one or more IBRs (e.g., a set of IBRs) to provide modulated reactive current that can mitigate weak grid oscillations. This can be realized through coordination and/or implementing a voltage feedback control to modulate the reactive current order of a set of IBRs.

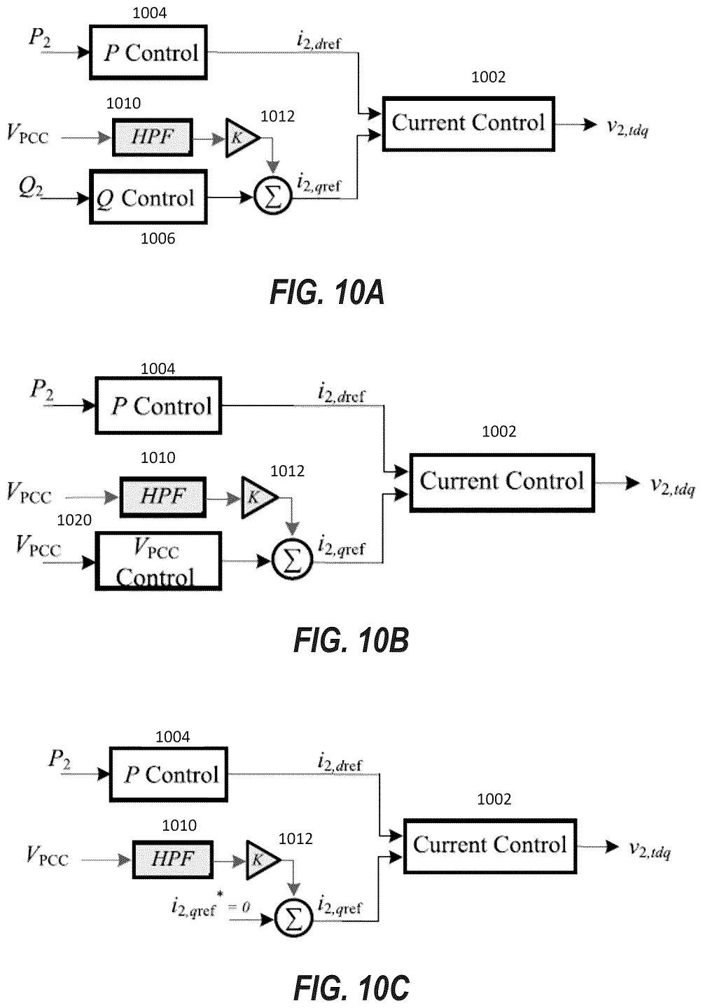

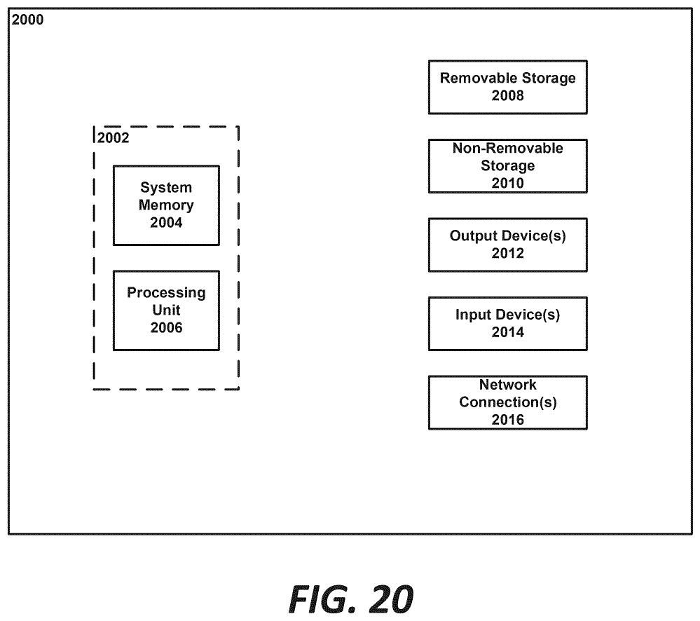

FIG. 10A-10C illustrate example implementations of the present disclosure. The example implementations include a feedback control system using a high-pass filter and parameter configurations that can be used to dampen oscillations (e.g., in IBRs). As shown in FIGS. 10A-10C implementations of the present disclosure can be configured as supplementary controllers with a gain and high pass filter. The supplementary controllers shown in FIGS. 10A-10C can be used for grid-forming and grid-following inverters, for example. The controllers and control units described herein can be implemented using the computing device 2000 shown in FIG. 20.

FIG. 10A illustrates an example control diagram for an IBR. The system

includes a current controller 1002, a real-power control unit 1004, and a reactive power control unit 1006. The high-pass filter 1010 and gain 1012 form a supplementary controller. Voltage feedback V_{PCC} is input to the high-pass filter 1010 and the gain 1012 can be applied before being summed with the reactive power control unit 1006′s output. The high-pass filter 1010 and gain 1012 can adjust the q-axis current to counter low-frequency voltage swings, while maintaining the existing real-power control unit 1004 and reactive power control unit 1006. The high-pass filter 1010 can therefore attenuate low-frequency voltage deviations at the point of common coupling. A non-limiting example of a high-pass filter that can be used is a high-pass filter with the transfer function

$$\frac{τ s}{τ s + 1} .$$

Here, 1/τ is the cutoff frequency of the HPF filter. The gain 1012 can be adjusted to provide flexibility.

FIG. 10B illustrates an alternative implementation of the example shown in FIG. 10A. In the implementation of FIG. 10B, the same real-power control unit 1004 can be used with the same current controller 1002. The reactive power control unit 1006 can be replaced with a voltage control 1020 that is summed with the signal from the supplementary controller.

FIG. 10C illustrates another alternative implementation of the example shown in FIG. 10A. In the implementation of FIG. 10C, the reactive power control unit 1006 is removed. However, the high pass filter 1010 and gain 1012 remain active as inputs to the current controller 1002. Thus, it should be understood that the reactive power control unit 1006 and voltage control 1020 are optional, and that some implementations of the present disclosure can have neither a reactive power control unit 1006 nor a voltage control 1020.

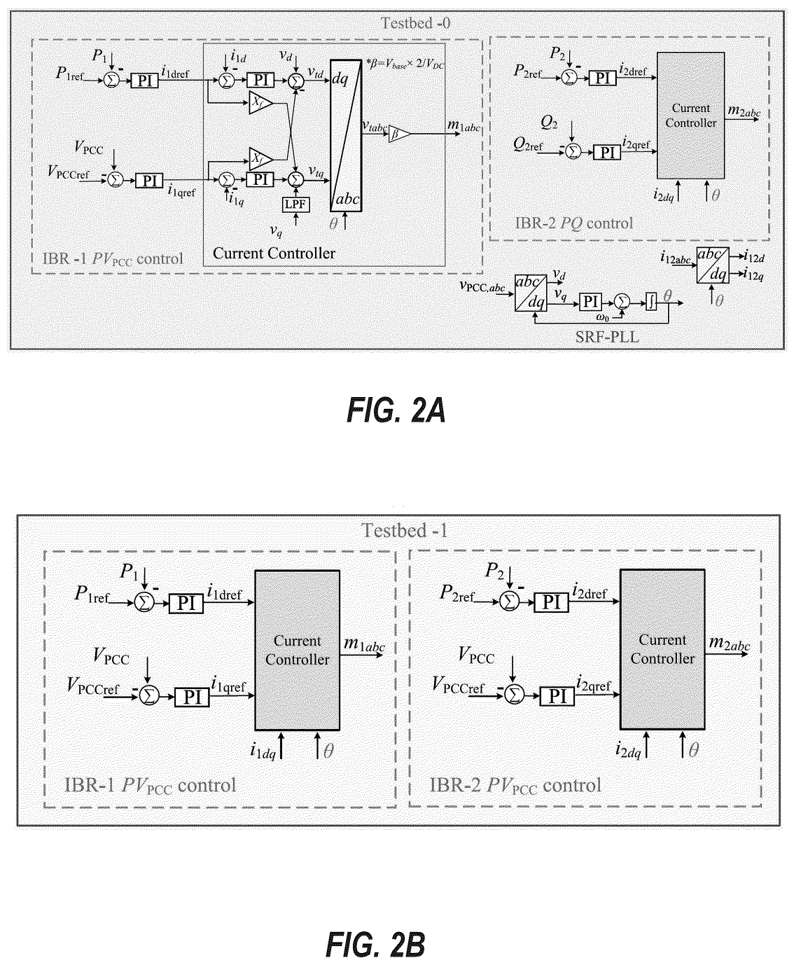

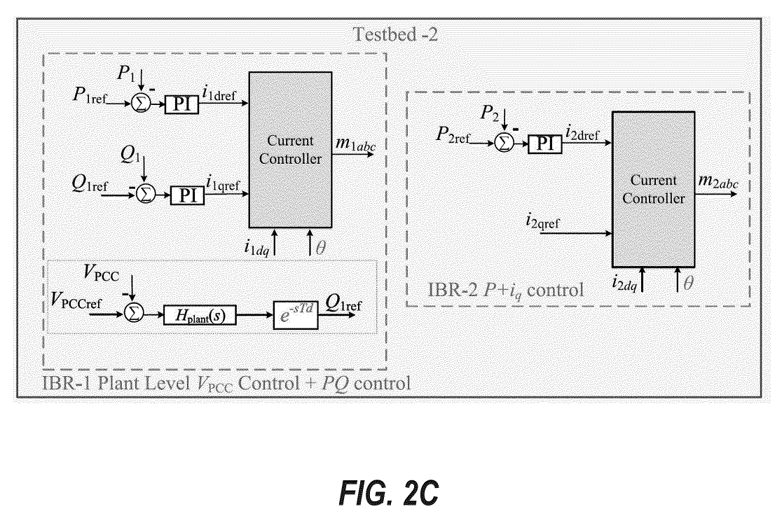

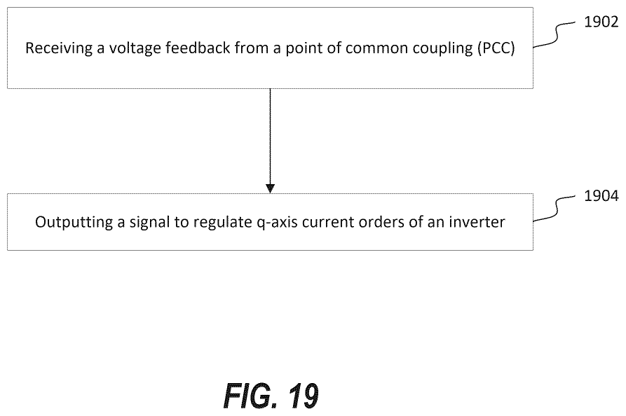

With reference to FIG. 19, an example computer-implemented method of controlling inverter-based resources is shown. The computer-implemented methods can be implemented using the system described with reference to FIGS. 2A-2C and 10A-10C, for example.

At step 1902, the method includes receiving a voltage feedback from a point of common coupling, where the point of common coupling joins a first inverter-based resource and a second inverter-based resource.

At step 1904, the method includes controlling the first inverter-based resource based on the voltage feedback to prevent weak-grid oscillations. The control of the first inverter-based resource can be performed based on a q-axis current of the first inverter- based resource. Optionally, the method can include performing coordinated reactive current control of the first inverter-based resource and the second inverter-based resource.

Optionally, the method can further include high-pass filtering the voltage feedback from the point of common coupling, wherein the high-pass filter configured is to attenuate a low-frequency voltage deviation.

### Example

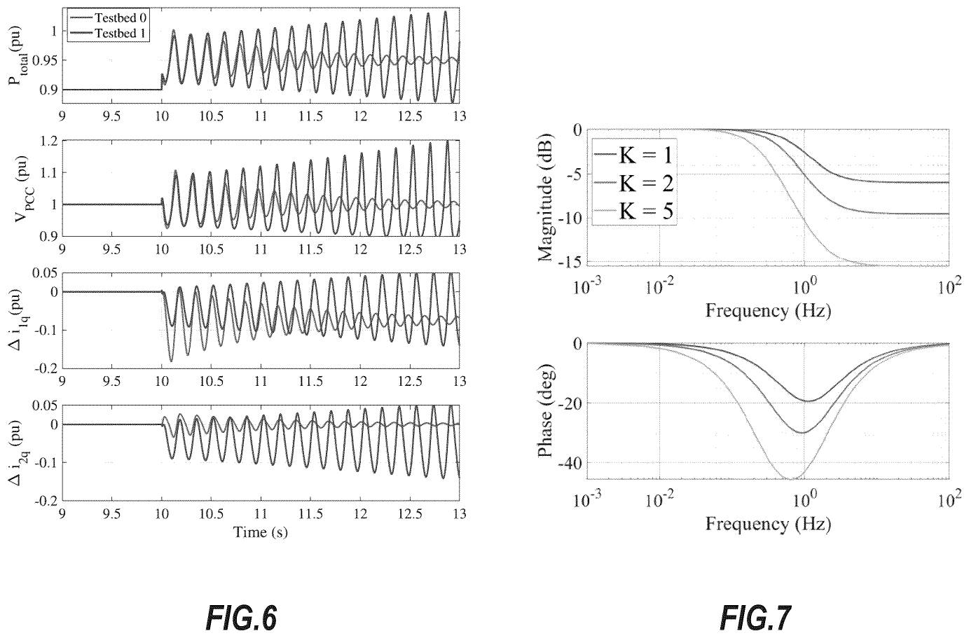

Existing systems and methods of stability enhancement for weak grids (e.g., those that rely on parameter turning) are limited. [1]-[18]. The present disclosure improves on these methods of stability enhancement by adding IBR coordination to a multi-IBR system. The example implementations shows that with one IBR in voltage control mode and another in reactive power control mode, the entire system can achieve better stability. There is room for additional improvement through coordination. The study described herein shows an effective coordination and control scheme that was designed, implemented, and tested. With the coordination and control scheme, the tests illustrated in FIG. 6 show that the total power from the two IBRs can achieve 1.06 p.u. for a very weak grid interconnection when the SCR is 1 p.u. Since there is 0.1 p.u. resistance in the grid impedance, the steady-state limit of operation (with voltage kept at 1 p.u.) is about 1.1 p.u. It is found that the coordination scheme can effectively push IBRs to operate close to the steady-state limit.

The example implementation demonstrates that proper coordination among IBRs is effective to improve stability. Identical control of IBRs is not necessarily the best. It is found that reducing the sensitivity of voltage towards reactive power or current can be achieved through IBR coordination.

The example implementation includes a simple and effective control design by exploring the voltage and reactive current relationship in weak grid oscillation scenarios. The study shows a theoretic analysis has been provided to show why such strategy can work and a thorough validation of the coordination and control scheme has been carried out in both EMT computer simulation and hardware experiments.

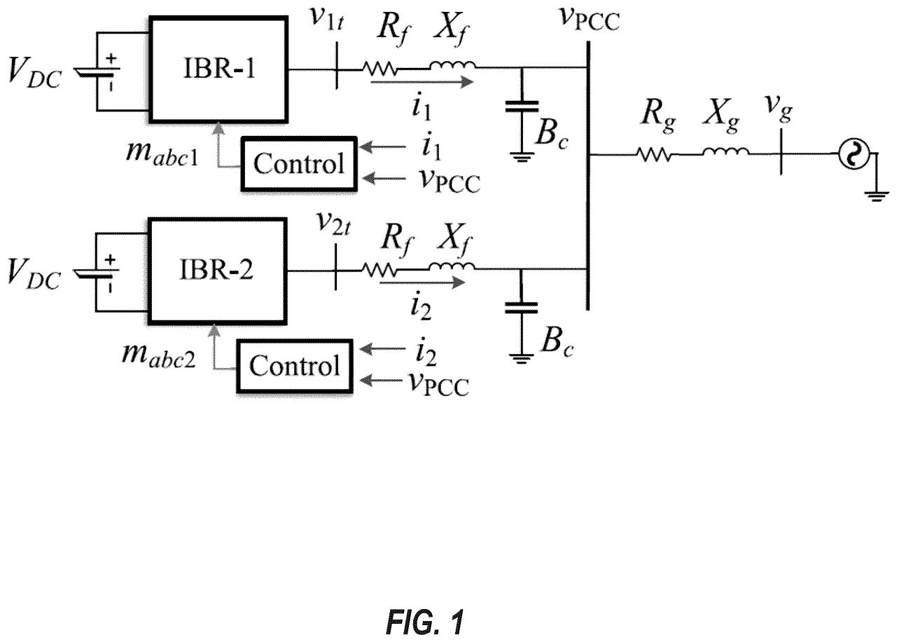

The schematics of an example system under study are illustrated in FIG. 1. The example system includes two three-phase DC-AC inverters connected in parallel at the PCC bus, which is further is connected to the power grid via a transmission line represented by R_{g} and X_{g}. A choke filter is connected between the terminals of the inverter. The choke filter is represented by R_{f}, X_{f} and C_{f}. A constant DC voltage source supplies each inverter. The AC grid is modeled as a constant voltage source (“infinite bus”).

Furthermore, i₁, and i₂ are the converters current for IBR-1 and IBR-2 respectively and v_{PCC} is the PCC bus voltage. Both the IBRs are grid-following inverters. The subscripts “1” and “2” represent IBR-1 and IBR-2 respectively. The study included three testbeds with different control structures are considered for the study.

In Testbed-1, the two IBRs have identical controls. The inner current control is implemented in the PLL-based dq frame, and the outer control regulates real power P and the PCC bus voltage v_{PCC}. The real power control generates i_{dref} for the d-axis current control and the voltage control generates i_{q ref} for the q-axis current control. A synchronous reference frame-PLL is used to synchronize the PCC voltage to the grid. The output angle (θ) from the PLL is used for frame conversion. The real power P₁ and the reactive power Q₁ are given by:

$${P}_{1} = {v}_{d} {i}_{1 d} + {v}_{q} {i}_{1 q}$$

Here, v_{d} and v_{g} are the dq components of v_{PCC}. Similarly, P₂ and Q₂ are defined. The magnitude of the PCC bus voltage is obtained as:

$${V}_{PCC} = \sqrt{{v}_{d}^{2} + {v}_{q}^{2}} \qquad ( 2 )$$

Additionally, a feed-forward filter (VFF) has been added to the feed-forward signal v₁ in the inner current control to enhance the system stability. The feed-forward filter is a low pass filter and the transfer function is

$$\frac{1}{{T}_{v f} s + 1} ,$$

where T_{vf} is the cutoff frequency.

For Testbed-2, IBR-1 and IBR-2 have different control structures for the outer control. The inner current controls are the same. For IBR-1, the d-axis outer control is the real power control, whereas in the q-axis control, the outer control is reactive power control. The reactive power order is generated from the plant-level voltage controller. For the plant-level control, the voltage reference order (V_{PCC, ref}) is compared with the measurement V_{PCC} and passed through an integral controller

$$( \frac{{k}_{i Plant}}{s} )$$

to generate the reactive power order (Q_{1, ref}). Additionally, a delay (e^{-T}^{_{d}}^{s}) is considered for the plant-level control and inverter-level control communication. IBR-2 shares the same d-axis outer loop control structure as IBR-1 but does not have q-axis outer loop control and i_{2,qref}*=0.

Testbed-0 is used to compare with Testbed-1 and show the necessity of coordination. In Testbed-0, IBR-1 and IBR-2 have different outer loop control, but the inner current control is the same. For IBR-1, the outer loop is real power P and PCC bus voltage V_{PCC} control, whereas IBR-2 has an outer loop in real power P and reactive power Q control. The rest of the control structure is similar to Testbed-1.

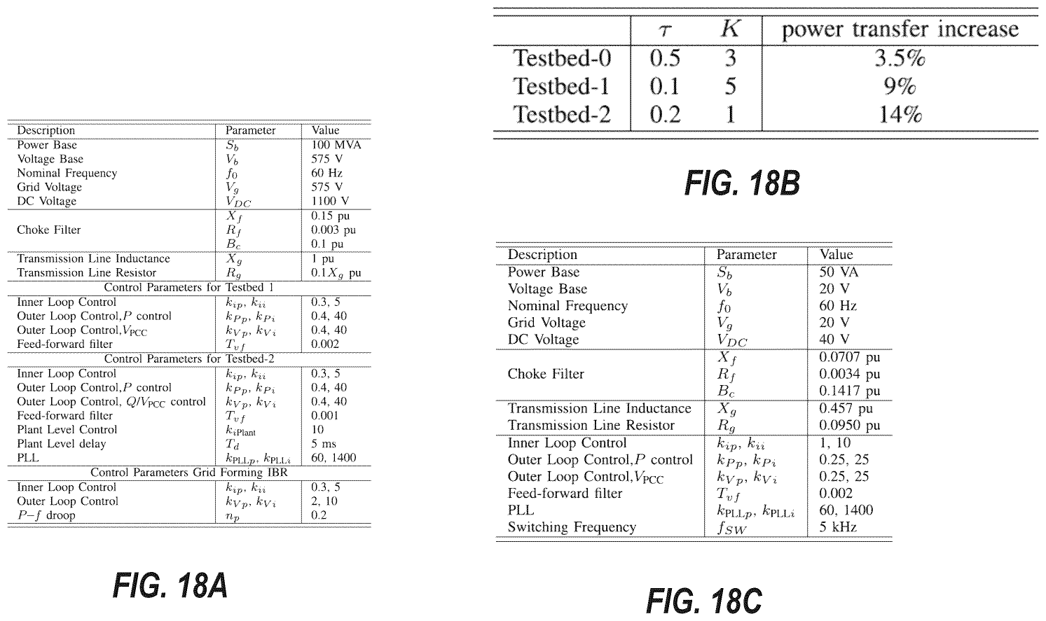

The detailed controller structures of Testbed-0, Testbed-1, and Testbed-2 are illustrated in FIGS. 2A-2C, respectively. The parameters for Testbed-0, Testbed-1, and Testbed-2 are presented in FIG. 18A. The controller gains are based on the per-unit system.

### Example Coordination Methodologies and Analysis The coordination philosophy is explained using a two-IBR system presented in

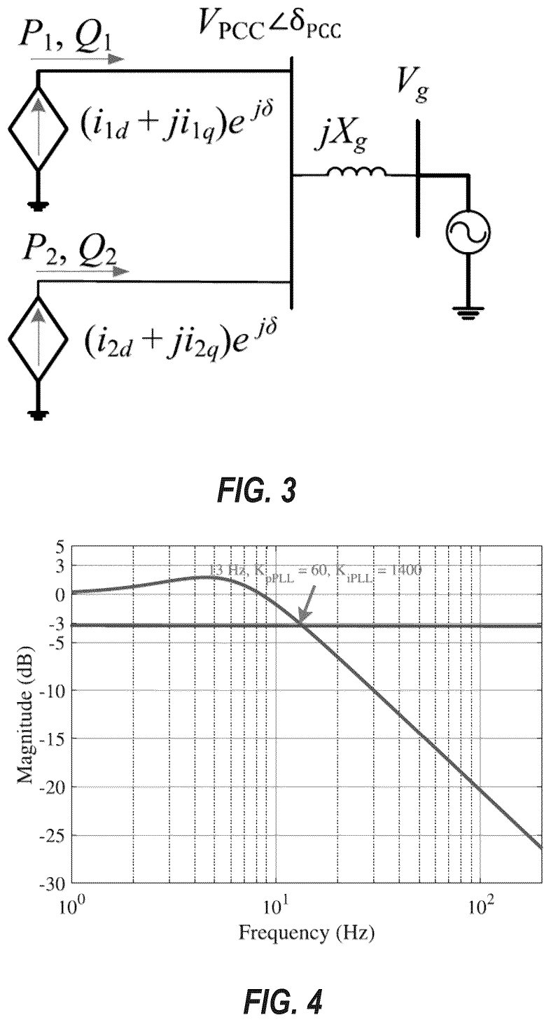

FIG. 3, with each IBR represented as a controllable current source.

The transmission line's resistance and electromagnetic dynamics are neglected. Hence, jX_{g} is used to represent the transmission line. The two IBRs adopt vector control [19], [20] in the dq frame, where the d axis of the frame is aligned with PCC bus voltage's space vector. The PCC bus voltage magnitude is directly related to the PLL angle δ (where δ=αθ=θ−ω₀t, and ω₀ is the nominal angular frequency). The d-axis outer control exerts influence on the PCC bus phase angle through the d-axis current.

In the following, a feedback system for a two-IBR system is derived. Based on the circuit shown in FIG. 3, the following relationship is obtained:

$${V}_{PCC} {e}^{j δ PCC} = j {X}_{g} ( {i}_{1 d} + j {i}_{1 q} + {i}_{2 d} + j {i}_{2 q} ) {e}^{j δ} + {V}_{g} \qquad ( 3 )$$

Here, δ_{PCC} is the PCC bus angle, δ is the angle from the PLL. Linearizing right-hand side (RHS) and left-hand side (LHS) (3), results in:

$$LHS = {e}^{j {δ}_{PCC}} {Δ V}_{PCC} + {j V}_{PCC} {e}^{j {δ}_{PCC}} Δ {δ}_{PCC} \qquad ( 4 )$$

$$RHS = {X}_{g} {e}^{j δ} [ j ( Δ {i}_{1 d} + Δ {i}_{2 d} )$$

At steady state δ_{PCC}=δ, and comparing real and imaginary parts of RHS and LHS, results in:

$${Δ V}_{PCC} = - {X}_{g} ( {i}_{1 d} + {i}_{2 d} ) Δ δ - {X}_{g} ( Δ {i}_{1 q} + Δ {i}_{2 q} )$$

$$Δ {δ}_{PCC} = \frac{{X}_{g}}{{V}_{PCC}} ( Δ {i}_{1 d} + Δ {i}_{2 d} - ( {i}_{1 q} + {i}_{2 q} ) Δ δ ) \qquad ( 5 )$$

In (5), assuming i_{1q}+i_{2q}=0, and G_{PLL}(s) is the transfer function from αδ_{PCC} to αδ, and re-arranging (5) results in:

$${Δ V}_{P C C} = - \underbrace{{X}_{g} ( {i}_{1 d} + {i}_{2 d} ) \frac{{X}_{g}}{{V}_{PCC}}}_{c} {G}_{PLL} ( s ) - {X}_{g} ( Δ {i}_{1 q} + Δ {i}_{2 q} ) \qquad \{ 6 )$$

From (6), for a two IBR system, αV_{PCC} has contributions from αi_{1d}, αi_{2d}, αi_{1q}, and αi_{2g}. Herein, PLL is designed to have a bandwidth of 13 Hz, as per the parameters of the PI gains as 60 and 1400. The Bode diagram is presented in FIG. 4. For the study, the concerned frequency range is less than 10 Hz. Hence, in this frequency range, PLL does not interfere with the dynamics of the system, i.e., G_{PLL}(s)=1.

A linear relationship is also found for the real power and the reactive power for both IBRs.

$$Δ {P}_{1} = {i}_{1 d 0} {Δ V}_{PCC} + {V}_{PCC} Δ {i}_{1 d}$$

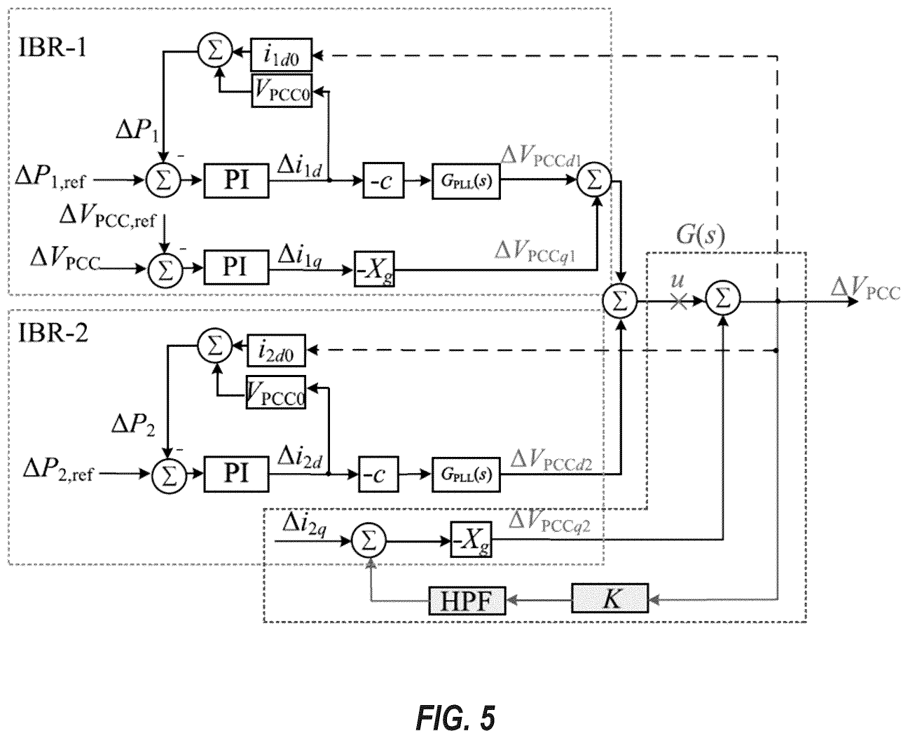

Similarly, expressions for αP₂ and αQ₂ are obtained. With the help of (6) and (7), a linear block system of the two-IBR system is constructed as shown in FIG. 5.

### Weak Grid Voltage Instability

The block diagram shows the coupling between the real power control and the PCC voltage. At weak grid conditions, X_{g} is large. Thus, a weak grid and high power transfer may lead to a large value of c. According to (6) and the block diagram, an increase in the power order will result in the increase in αi_{d} and in turn the reduction of αV_{PCC}. This may cause αP to reduce. Hence, if the effect of αi_{d} on voltage is overwhelming, αP may not follow the power order, introducing an instability mechanism. More details on the instability mechanism can be found in [21] and [22]. Since the instability is mainly due to the high sensitivity of voltage towards current injection in weak grids, this type of instability is referred to herein as voltage stability.

### Coordination

Inverters with fast voltage control can achieve better stability [17], [23] by making the inverter behave like a voltage source. Therefore, voltage control is usually assumed

to achieve better stability, e.g., [16], [17]. On the other hand, in a two-IBR system, IBRs having identical control, (either power and voltage-PV or power and reactive power-PQ control) vs. IBRs having different control modes do not necessarily work better. The study of the example implementation shows that with one IBR in PV control and another in PQ control mode, the entire system can achieve better stability.

The comparison results are presented as follows for a step change in the power order. Testbed-0 has IBR-1 in the PV control mode and IBR-2 in the PQ control mode, while Testbed-1 has both IBR working under the PV control mode. The control structure is illustrated in FIGS. 2A-2C. The results are presented in FIG. 6. Under similar weak grid conditions (SCR≈1), Testbed-0 shows better stability, while Testbed-1 goes to an unstable condition.

Thus, how the q-axis current is controlled matters. Proper coordination of the reactive current control among inverters can help improve stability. The study therefore includes a detailed examination on the relationship between voltage and the q-axis current.

Coordination and Control Enhancement

The coordination of IBR is developed after examining AEMO's success in identifying the source of 7-Hz oscillations in west Murray [24], [5]. Five solar farms were pinpointed as the negative influencers. The critical technology in identifying the five troublemakers is essentially observing the phase shift between voltage (V) and reactive power (Q) output from each IBR under 7-Hz perturbation. If V and Q are in phase, this IBR contributes to the oscillation mode. On the other hand, if V and Q are out of phase, the IBR is mitigating the oscillation.

From the physics point of view, in the low-frequency range (ignoring very fast transmission line electromagnetic dynamics), it is well known that injecting reactive power into a grid can cause an increase in voltage. The mathematical relationship is as follows:

$$Δ V \approx {X}_{g} Δ Q \approx - {X}_{g} Δ {i}_{q} \qquad ( 8 )$$

where X_{g} is the grid reactance. Note that the above simplified relationship has ignored the effect of real power and/or real current i_{d}'s effect on voltage. A relationship between αV and dq current has been presented in (6).

This relationship is based on the well-known relationship between the reactive power injection and voltage. Reference [25 ] has used the same insight to explaining the wind turbine var oscillations. Also in [26], a similar expression has been used to explain oscillations in parallel a solar PV and a battery energy storage system.

If there are two IBRs connected to the point of interconnection, the voltage will have contributions from the reactive current injection from both IBRs. The equation can be modified as:

$$Δ V \approx \underbrace{- {X}_{g} Δ {i}_{1 q}}_{Δ {V}_{1}} + \underbrace{( - {X}_{g} Δ {i}_{2 q} )}_{Δ {V}_{2}} \qquad ( 9 )$$

It is possible that αV₁ and αV are in phase while αV₂ and αV are out of phase, which implies that IBR-1 contributes to oscillations and is the negative influencer while IBR-2 mitigates oscillations and is the positive influencer.

Consequently, the above remarks explain the comparison results in FIG. 6. It can be seen that in Testbed-1 when both IBRs are in the voltage control mode, both reactive powers (currents) contribute to the oscillations. On the other hand, when IBR-2 changes its control mode, IBR-2's reactive power or reactive current contributes less to the oscillation. Therefore, implementations of the present disclosure can coordinate IBR controls to make further improvements.

Our philosophy is to have one or more IBRs provide damping through counter reactive power. To achieve this goal, an IBR has to be designed to have its q-axis current order modulated by the positive feedback of voltage deviation. For the two-IBR system, IBR-2′s q-axis current order will be modulated.

$$Δ {i}_{q 2} \approx Δ {i}_{q 2}^{*} = k Δ V , ⇒ Δ {Q}_{2} \approx - V Δ {i}_{q 2} ∝ - ΔV \qquad ( 10 )$$

Based on (7), αQ₂=−Vαi_{q2}−i_{2q0}αV. Assuming that the initial q-axis current is 0 or IBR-2 is not providing nor absorbing significant reactive power, αQ₂≈−Vαi_{q2}. Hence, when the q-axis current order is modulated to be proportional to αV, the resulting reactive power modulation αQ₂ counters αV and can mitigate voltage oscillations.

### Control Implementation

The control strategy includes modulating one group of IBR's q-axis current order according to the voltage deviation. This is achieved by the feedback of PCC voltage signal V_{PCC} after passing through a high-pass filter (HPF) with a transfer function

$$\frac{τ s}{τ s + 1} .$$

Here, 1/τ is the cutoff frequency of the HPF filter. An additional gain K is added to provide flexibility. The control is implemented in the multi-IBR system linear block diagram as shown in FIGS. 10A-10C. The transfer function from u (aggregated effect of αi_{1d}, αi_{1q} and αi_{2d} on the PCC voltage) to αV_{PCC} is given by:

$$G ( s ) = \frac{1}{1 + {X}_{g} HPF} = \frac{1}{1 + {X}_{g} K \frac{τ s}{1 + τ s}} = \frac{1 + τ s}{1 + s τ ( {X}_{g} K + 1 )} \qquad ( 11 )$$

Without the feedback, Gₛ=1. From (11), the transfer function imitates a low-pass filter (LPF). The Bode diagrams of the transfer function for X_{g}=1.0, τ=0.1 s and for different parameters of K are presented in FIG. 7. From FIG. 7, the cutoff frequency for K=1, is around 1.1 Hz. For 6-Hz oscillations, the HPF-based control can effectively reduce the loop gain to 18% of the original gain when K is 5, thereby significantly increasing the oscillation stability margin. The gain of the transfer function G(s) is unity without the HPF controller. With the feedback controller, the gain of the transfer function is reduced in the region of several Hz for more than 5 dB. Hence, the coupling between the dq-axis current and the αV_{PCC} is also decreased. Thus, the HPF controller is beneficial for weak grid voltage stability.

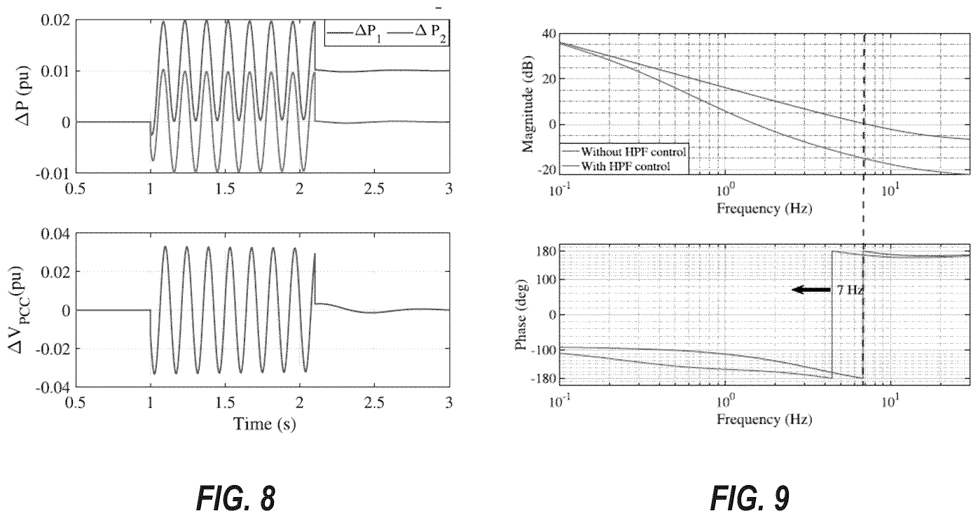

Linear Model-Based Analysis. The block diagram presented in FIG. 5 is built in MATLAB/Simulink. The following operating condition is assumed: P_{1, ref}=P_{2, ref}=0.5 p.u., and V_{PCC} is maintained at 1 p.u. A small step change of 1% is applied in αP_{1, ref}. The simulation results in FIG. 8 show that the system undergoes poorly damped oscillations of about 7 Hz. When the HPF control is enabled, the oscillations are damped out. The selected parameters for the stability controller are τ=0.1 s and K=5.

Further investigation was conducted in the frequency domain by analyzing the open-loop transfer function. The open-loop system was obtained by breaking at the point marked a cross in FIG. 5. The transfer function obtained is from u to αV_{PCC}. The Bode diagram is presented in FIG. 9. It is observed that without the HPF controller, the phase shifting occurs at 7 Hz and the gain margin at this point is 0 dB, which implies a marginally stable system. After the addition of the HPF controller (red curve), the system is stable at the 7 Hz frequency point with a positive gain margin. This observation is in coherence with the time-domain results presented in FIG. 8. It can be seen that the HPF controller makes G(s) (from u to αV_{PCC}) act as a LPF and effectively reduce the open-loop gain in the several Hz region. In turn, it enhances stability.

### Electromagnetic Transient (EMT) Simulations

The three testbeds presented in Section II are simulated in MATLAB/Simscape Electrical. EMT simulations are conducted with the short-circuit ratio (SCR) at 1.0 p.u. The HPF-based voltage feedback is introduced in IBR-2 for all three testbeds to modulate its q-axis current order, as shown in FIGS. 10A-10C. Two tests (small disturbance and large disturbance) are conducted for each testbed to demonstrate the advantage of HPF control. The IBRs in the three testbeds are all adopting grid-following control (GFL). Furthermore, the HPF control is also tested for grid-forming control (GFM). The parameters in FIG. 18A I are used for IBR controls.

Small Disturbance Tests: Power Order Increase. For the first test, the power order of the two IBRs is increased in steps. For Testbed-0, when IBR-1 is at 0.44 pu, and IBR-2 at 0.5 pu, the system undergoes poorly damped oscillations of about 6 Hz. For Testbed-1, when the power orders of IBR-1 and IBR-2 are 0.474 p.u. and 0.5 p.u. (i.e., total power output is 0.974 p.u.) respectively, the system experiences low-frequency oscillations. The frequency of the oscillations is 6.5 Hz. A similar power order increase is implemented in Testbed-2. When P_{1, ref}=0.55 p.u. and P_{2, ref}=0.3 p.u., the system undergoes 3.2-Hz oscillations.

Selection of HPF parameters: The HPF feedback control is implemented in IBR-2. The parameters for the feedback control are the HPF's time constant τ and the gain K. The selected values for Testbed-1, and Testbed-2 are listed in FIG. 18B. In Testbed-0, the oscillation frequency is 6 Hz, and HPF parameters of 0.5 s and 3 provide sufficient damping to mitigate the 6 Hz oscillations. For Testbed-1, the oscillation frequency is about 6.5 Hz, hence the time constant at 0.1 s and the gain at 5 can provide a sufficient gain reduction in the frequency region. On the other hand, Testbed-2 has an oscillation frequency of 3.2 Hz. Though the same control can provide gain reduction at 3.2 Hz, it also introduces a phase lag of more than 20°. To have a smaller phase lag, the time constant 0.2 s and the gain 1 are used for Testbed-2.

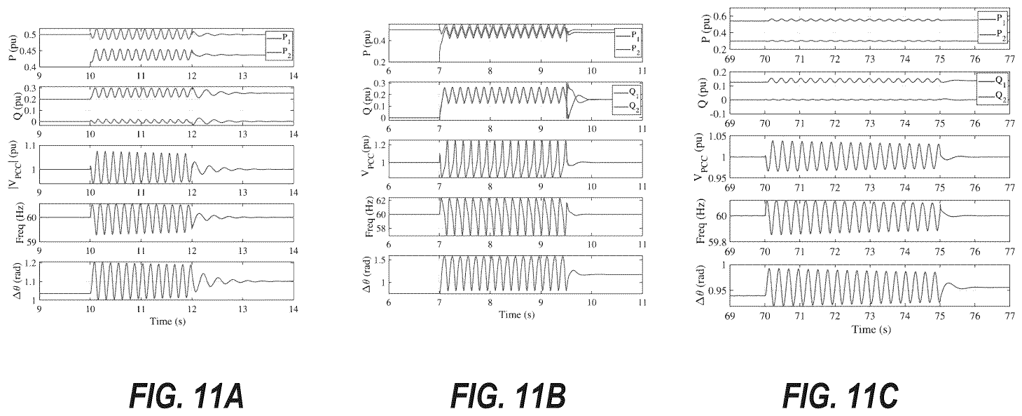

Enabling the feedback control in IBR-2 mitigates the 6-Hz oscillations in Testbed-0, the 6.5-Hz oscillations in Testbed-1, and 3.2-Hz oscillations in Testbed-2. The dynamic responses of the real power P, reactive power Q, PCC bus voltage V_{PCC}, and the output from the PLL (frequency, and the angle αθ) for IBRs are presented in FIGS. 11A-11C. It can be seen that the HPF control mitigates the weak grid oscillations in all the cases.

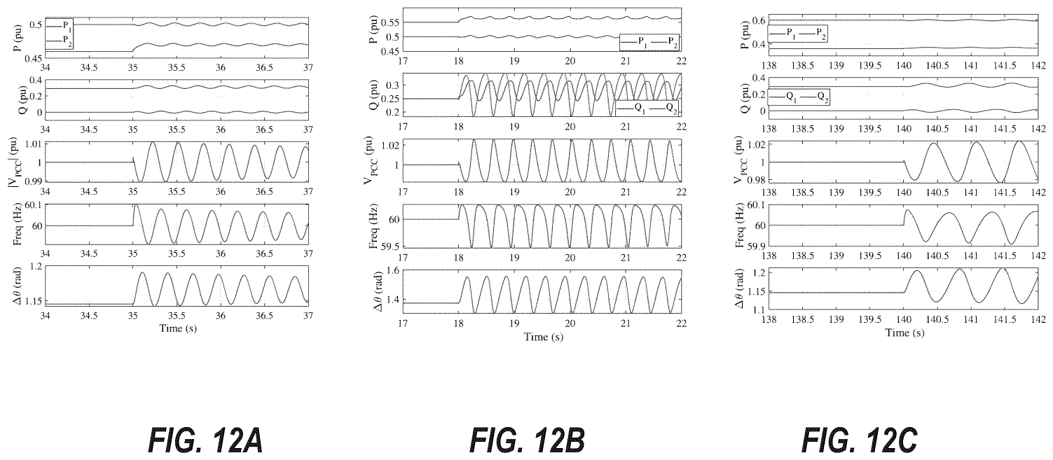

For Testbed-0, with the added controller, the power exporting capability of the two IBRs increases from 0.937 p.u. to 0.97 p.u., a 3.5% increase. For Testbed-1, with the added controller, the power exporting capability of the two IBRs increases from 0.974 p.u. to 1.064 pu, a 9% increase. While for Testbed-2, the power transfer capability increases from 0.85 p.u. to 0.97 p.u. i.e., 14% increase. For Testbed-1, the power transfer is close to the steadystate limit (1.1 p.u.) associated with X_{g}=1 p.u. The simulation results at the marginal stable conditions are illustrated in FIGS. 12A-12C. The HPF controller can mitigate weak grid oscillations (6.5 Hz and 3.2 Hz) for different scenarios, showing the robustness of control. The HPF control helps increase the stability margin of multi-IBR systems. The HPF control does not change steady-state operating conditions.

### Large Disturbance Tests: Line Tripping

Furthermore, large disturbance tests were conducted to emulate a

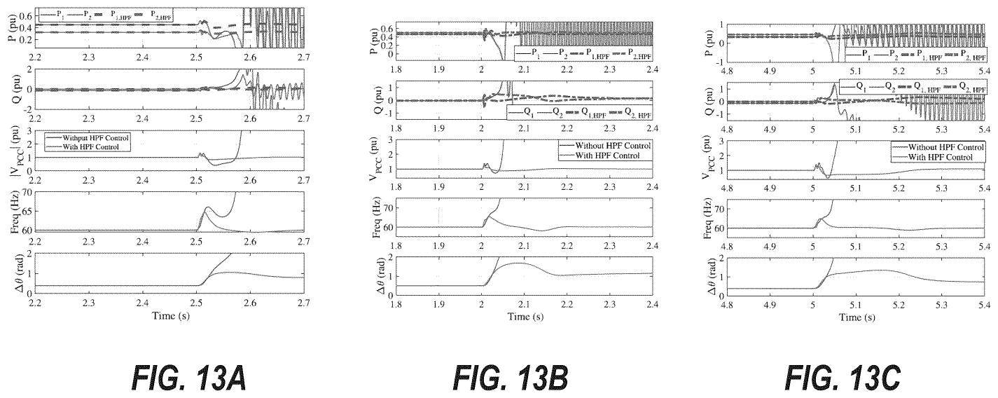

transmission line tripping event. For both testbeds, X_{g} changes from 0.5 (SCR≈2) to X_{g}=1.0 (SCR≈1). Without the feedback control strategy, the system loses its synchronism and becomes unstable. With feedback control, the system remains stable and sustains the large disturbance. The results for the line tripping event are presented in FIGS. 13A-13C. For Testbed-0, the line trip event happens at t=2.5 s, and the total power output is 0.77 pu (P1 =0.45 p.u., and P₂=0.32p.u.). For Testbed-1, at t=2 s, X_{g} changes from 0.5 p.u. to 1.0 p.u. The total power output from both IBRs is 0.95 pu (P₁=0.45 pu, and P₂=0.5 pu). While for Testbed-2, the line trip event happens at t=5 s, and the total power output is 0.77 pu (P₁=0.45 p.u., and P₂=0.32 p.u.).

### Grid Forming Converter

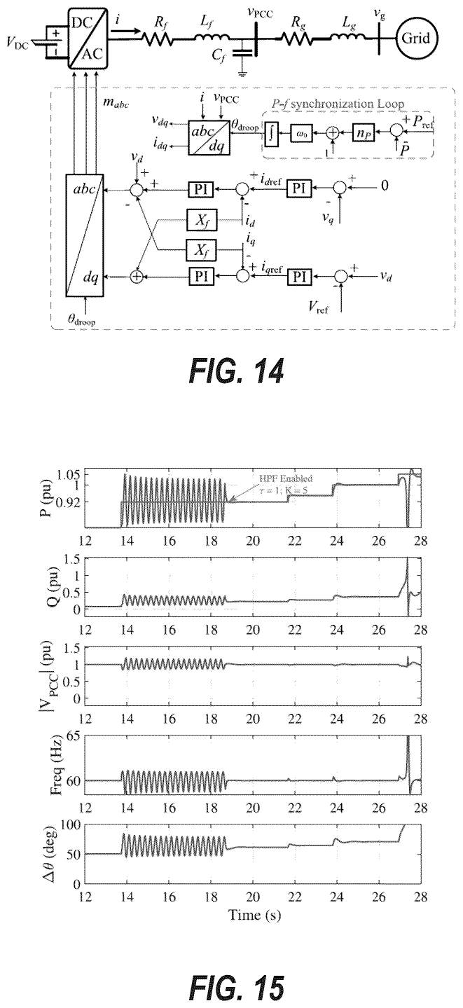

Further investigation was done on the effectiveness of a stability enhancement strategy for a single grid-forming inverter operating under weak grid conditions. Under weak grid conditions, oscillations may appear [27], [28]. The system topology and control structure used in the study is depicted in FIG. 14, with the control structure being adapted from the works of [29], [30]. Detailed parameters are provided in FIG. 18A. Under weak grid conditions, when the reference power output, P_{ref}, was set to 0.92, the system exhibited poorly damped oscillations with a frequency of approximately 4 Hz. The HPF controller was enabled, which effectively mitigated the oscillations. Consequently, the system could now sustain a power output of around 1.04 per unit (pu) before encountering instability. The results are presented in FIG. 15.

### Hardware Validation

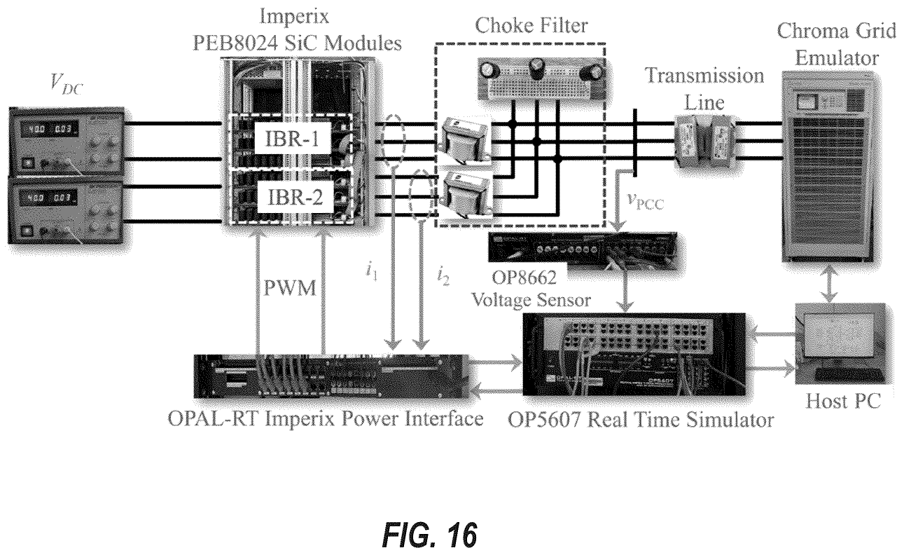

To further study the example implementation of a stability feedback control scheme, a laboratory-scale hardware testbed was established. The hardware testbed included two three-phase converters consisting of 6 Imperix PEB8024 half-bridge power modules, Chroma Regenerative Grid Simulator 61845 acting as power grid source, Opal RT's OP5607 real-time simulator for control algorithm implementation, analog voltage and current sensors, DC power supply and other passive elements. The detailed structure of the hardware testbed is presented in FIG. 16. The control algorithm is implemented using MATLAB-based RT-Lab on the host PC. Similarly, the Chroma Grid emulator is also controlled remotely using LabVIEW.

Both the inverters are in real power and PCC voltage regulation mode. The system strength as observed by the two IBRs at the PCC bus is 2.18 (X_{g}=0.457 p.u.). The steady-state power limit corresponding to X_{g}=0.457 p.u. and R_{g}=0.0950 p.u. is 2.578 p.u. The testbed parameters are tabulated in FIG. 18C.

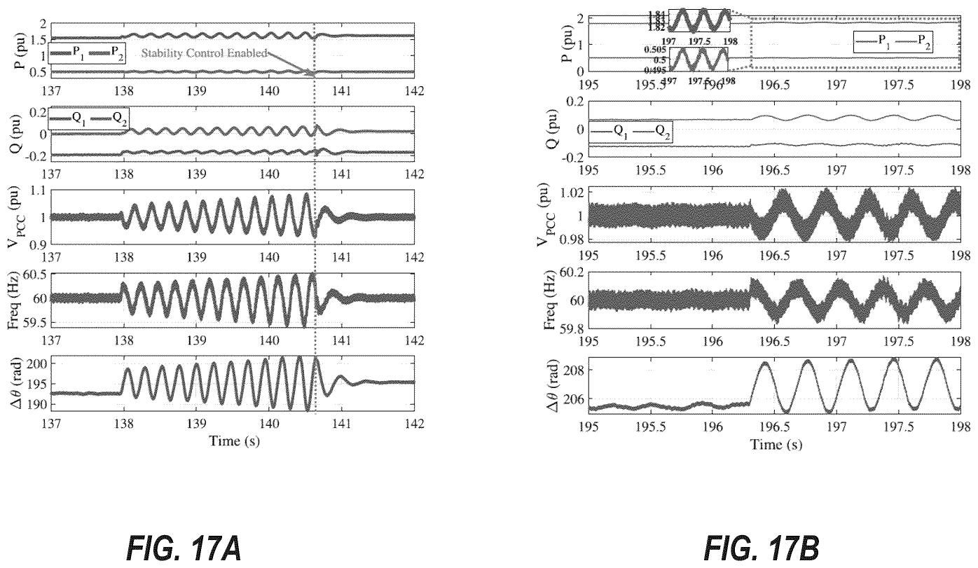

The power order was increased in small steps for IBR-1, while the power order for IBR-2 was kept at P_{2, ref}=0.5 p.u. Initially, the stability control is disabled. When the power output from IBR-1 is 1.62 p.u the system undergoes poorly damped 4-Hz oscillations. After the occurrence of the oscillations, the HPF stability control is enabled at t=141.5 s, which mitigates the oscillations. The results are shown in FIG. 17A. The parameters selected for the HPF stability control are K=2, and τ=0.1 s.

Furthermore, with the stability control enabled, the system is marginally stable when IBR-1 power output level is 1.83 p.u. while the IBR-2 is still exporting 0.5 p.u., as shown in FIG. 17B. The experimental validation demonstrates the efficacy of the proposed stability controller. By employing the example implementation of a control system, the multi-IBR system increases stability margin while operating in very weak grid conditions. Furthermore, with one group of IBR's q-axis current orders modulated by a voltage feedback, the effect is similar as reducing the coupling between the VSC's real power control and the PCC voltage. This effect helps enhance weak grid voltage stability. The coordination can be implemented by feedbacking of the PCC bus voltage after passing it through a high-pass filter. Linear analysis, EMT-based computer simulation, and hardware experiments all confirm the efficacy of the stability enhancement strategy. In addition, the strategy is simple and straightforward for implementation and is robust against the host system. Variety of control structures, including GFL and GFM, have been tested. Therefore, it leads to high practical values.

It should be appreciated that the logical operations described herein with respect to the various figures may be implemented (1) as a sequence of computer implemented acts or program modules (i.e., software) running on a computing device (e.g., the computing device described in FIG. 20), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 20, an example computing device 2000 upon which the methods described herein may be implemented is illustrated. It should be understood that the example computing device 2000 is only one example of a suitable computing environment upon which the methods described herein may be implemented. Optionally, the computing device 2000 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 2000 typically includes at least one processing unit 2006 and system memory 2004. Depending on the exact configuration and type of computing device, system memory 2004 may be volatile (such as random access memory (RAM)), non-volatile (such as read-only memory (ROM), flash memory, etc.), or some combination of the two. This most basic configuration is illustrated in FIG. 20 by dashed line 2002. The processing unit 2006 may be a standard programmable processor that performs arithmetic and logic operations necessary for operation of the computing device 2000. The computing device 2000 may also include a bus or other communication mechanism for communicating information among various components of the computing device 2000.

Computing device 2000 may have additional features/functionality. For example, computing device 2000 may include additional storage such as removable storage 2008 and non-removable storage 2010 including, but not limited to, magnetic or optical disks or tapes. Computing device 2000 may also contain network connection(s) 2016 that allow the device to communicate with other devices. Computing device 2000 may also have input device(s) 2014 such as a keyboard, mouse, touch screen, etc. Output device(s) 2012 such as a display, speakers, printer, etc. may also be included. The additional devices may be connected to the bus in order to facilitate communication of data among the components of the computing device 2000. All these devices are well known in the art and need not be discussed at length here.

The processing unit 2006 may be configured to execute program code encoded in tangible, computer-readable media. Tangible, computer-readable media refers to any media that is capable of providing data that causes the computing device 2000 (i.e., a machine) to operate in a particular fashion. Various computer-readable media may be utilized to provide instructions to the processing unit 2006 for execution. Example tangible, computer- readable media may include, but is not limited to, volatile media, non-volatile media, removable media and non-removable media implemented in any method or technology for storage of information such as computer readable instructions, data structures, program modules or other data. System memory 2004, removable storage 2008, and non-removable storage 2010 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 2006 may execute program code stored in the system memory 2004. For example, the bus may carry data to the system memory 2004, from which the processing unit 2006 receives and executes instructions. The data received by the system memory 2004 may optionally be stored on the removable storage 2008 or the non-removable storage 2010 before or after execution by the processing unit 2006.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### References

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.
[1] H. Holttinen et al., “Variable renewable energy integration: Status around the world,” IEEE Power Energy Mag., vol. 19, no. 6, pp. 86-96, Nov.Dec. 2021.
[2] B. Badrzadeh et al., “System strength,” CIGRE Sci. Technol. J., vol. 20, February 2021, pp. 5-26.
[3] S.-H. Huang, J. Schmall, J. Conto, J. Adams, Y. Zhang, and C. Carter, “Voltage control challenges on weak grids with high penetration of wind generation: ERCOT experience,” in Proc. IEEE Power Energy Soc. Gen. Meeting, 2012, pp. 1-7.
[4] C. Li, “Unstable operation of photovoltaic inverter from field experiences,” IEEE Trans. Power Del., vol. 33, no. 2, pp. 1013-1015 April 2018.
[5] A. Jalali, B. Badrzadeh, J. Lu, N. Modi, and M. Gordon, “System strength challenges and solutions developed for a remote area of australian power system with high penetration of inverter-based resources,” CIGRE Sci. Eng. J., vol. 20, pp. 27-37, 2021.
[6] Y. Cheng et al., “Real-world subsynchronous oscillation events in power grids with high penetrations of inverter-based resources,” IEEE Trans. Power Syst., vol. 38, no. 1, pp. 316-330, January 2023.
[7] L. Fan et al., “Real-world 20-hz IBR subsynchronous oscillations: Signatures and mechanism analysis,” IEEE Trans. Energy Convers., vol. 38, no. 1, pp. 316-330, January 2023.
[8] B. Wen, D. Boroyevich, R. Burgos, P. Mattavelli, and Z. Shen, “Analysis of DQ small-signal impedance of grid-tied inverters,” IEEE Trans. Power Electron., vol. 31, no. 1, pp. 675-687, January 2016.
[9] NERC, “Integrating InverterBased resources into low short circuit strength systems,” North Amer. Electric Rel. Corporation, Atlanta, GA, USA, Tech. Rep., 2017. [Online]. Available: https://www.nerc.com/comm/RSTC_Reliability_Guidelines/Item_4a.Integrating%20_Inverter-Based_Resources_into_Low_Short_Circuit_Strength_Systems-_2017 Nov. 8-FINAL.pdf
[10] L. Huang, C. Wu, D. Zhou, and F. Blaabjerg, “A double-PLLs-based impedance reshaping method for extending stability range of gridfollowing inverter under weak grid,” IEEE Trans. Power Electron., vol. 37, no. 4, pp. 4091-4104 April 2022.
[11] S. Almutairi, Z. Miao, and L. Fan, “Stability analysis of two types of g rid-forming converters for weak grids,” Int. Trans. Elect. Energy Syst., vol. 31, no. 12, 2021, Art. no. e13136.
[12] C. Guo, W. Liu, C. Zhao, and R. Iravani, “A frequency-based synchronization approach for the VSC-HVDC station connected to a weak ac grid,” IEEE Trans. Power Del., vol. 32, no. 3, pp. 1460-1470 June 2017.
[13] C. Li, S. Wang, F. Colas, and J. Liang, “Dominant instability mechanism of VSI connecting to a very weak grid,” IEEE Trans. Power Syst., vol. 37, no. 1, pp. 828-831, January 2022.
[14] H. Gong, X. Wang, and L. Harnefors, “Rethinking current controller design for PLL-synchronized VSCs in weak grids,” IEEE Trans. Power Electron., vol. 37, no. 2, pp. 1369-1381 February 2022.
[15] L. Fan, “Modeling type-4 wind in weak grids,” IEEE Trans. Sustain. Energy, vol. 10,no. 2, pp. 853-864, April 2019.
[16] A. Egea-Alvarez, S. Fekriasl, F. Hassan, and O. Gomis-Bellmunt, “Advanced vector control for voltage source converters connected to weak grids,” IEEE Trans. Power Syst., vol. 30, no. 6, pp. 3072-3081 November 2015.
[17] Y. Li, L. Fan, and Z. Miao, “Stability control for wind in weak grids,” IEEE Trans. Sustain. Energy, vol. 10, no. 4, pp. 2094-2103 October 2019.
[18] G. Wu et al., “Low-frequency converter-driven oscillations in weak grids: Explanation and damping improvement,” IEEE Trans. Power Syst., vol. 36, no. 6, pp. 5944-5947 November 2021.
[19] A. Yazdani and R. Iravani, Voltage-Sourced Converters in Power Systems: Modeling, Control, and Applications. Hoboken, NJ, USA: Wiley, 2010.
[20] L. Fan, Control and Dynamics in Power Systems and Microgrids. Boca Raton, FL, USA: CRC Press, 2017.
[21] L. Fan and Z. Miao, “An explanation of oscillations due to wind power plants weak grid interconnection,” IEEE Trans. Sustain. Energy, vol. 9, no. 1, pp. 488-490, January 2018.
[22] Y. Li, L. Fan, Y. Zhou, and Z. Miao, “Stability enhancement module for grid-following converters: Hardware implementation and validation,” Int. Trans. Elect. Energy Syst., vol. 31, no. 11, 2021, Art. no. e13115.
[23] D. Ramasubramanian, W. Baker, J. Matevosyan, S. Pant, and S. Achilles, “Asking for fast terminal voltage control in grid following plants could provide benefits of grid forming behavior,” IET Gener., Transmiss. Distrib., vol. 17, no. 2, pp. 411-426, 2022.
[24] B. Badrzadeh, N. Modi, N. Crooks, and A. Jalali, “Power system operation with reduced system strength for inverter-connected generation during prior outage conditions,” CIGRE Sci. Eng., vol. 17, pp. 141-149, 2020.
[25] L. Fan, Z. Miao, and S. Shah, “Mechanism analysis of wind turbine var oscillations,” IEEE Trans. Ind. Electron., vol. 70, no. 10, pp. 10750-10754, October 2023.
[26] L. Fan, Z. Miao, S. Shah, P. Koralewicz, and V. Gevorgian, “Solar PV and BESS plant-level voltage control and interactions: Experiments and analysis,” IEEE Trans. Energy Convers., vol. 38, no. 2, pp. 1040-1049 June 2023.
[27] R. Mittal and Z. Miao, “Linear time-periodic modeling of single-phase elementary phase-locked-loop,” in Proc. IEEE 52nd North Amer. Power Symp., 2021, pp. 1-6.
[28] R. Mittal, L. Fan, and Z. Miao, “Harmonic state-space model of secondorder generalized integrator phase-locked loop,” in Proc. IEEE Power Energy Soc. Gen. Meeting, 2021, pp. 1-5.
[29] D. Ramasubramanian, E. Farantatos, O. Ajala, S. Dhople, and B. Johnson, “A universal grid-forming inverter model and simulation-based characterization across timescales,” in Proc. IEEE 56th Annu. Hawaii Int. Conf. System Sci., 2023, pp. 2631-2640.
[30] L. Fan and Z. Miao, Modeling and Stability Analysis of Inverter-Based Resources. Boca Raton, FL, USA: CRC Press, 2023.

What is claimed:

1. A grid control system comprising:
an inverter coupled to a point of common coupling (PCC); and
a controller configured to receive a voltage feedback from the point of common coupling and regulate a q-axis current order of the inverter.

2. The system of claim 1, further comprising a high-pass filter configured to filter the voltage feedback from the point of common coupling, wherein the high-pass filter configured is to attenuate low-frequency oscillations.

3. The system of claim 1, wherein the controller is configured to control a q-axis current of the inverter.

4. The system of claim 1, wherein the controller is configured to perform coordinated reactive current control of the inverter.

5. The system of claim 1, wherein the PCC couples one or more inverters.

6. The system of claim 1, wherein the inverter is configured as a grid-forming inverter.

7. The system of claim 1, wherein the inverter is configured as a grid-following inverter.

8. A computer-implemented method of controlling an inverter, comprising:
receiving a voltage feedback from a point of common coupling (PCC); and
outputting a signal to regulate a q-axis current order of the inverter.

9. The computer-implemented method of claim 8, further comprising high-pass filtering the voltage feedback from the point of common coupling, wherein the high-pass filtering configured is to attenuate low-frequency oscillations.

10. The computer-implemented method of claim 8, further comprising controlling a q-axis current of the inverter.

11. The computer-implemented method of claim 8, further comprising performing coordinated reactive current control of the inverter.

12. The computer-implemented method of claim 8, wherein the PCC couples one or more inverters.

13. The computer-implemented method of claim 12, wherein the one or more inverters each are configured as part of an inverter-based resource.

14. The computer-implemented method of claim 8, wherein the inverter is configured as a grid-forming inverter.

15. The computer-implemented method of claim 8, wherein the inverter is configured as a grid-following inverter.

16. A non-transitory computer-readable medium having instructions stored therein, wherein execution of the instructions by a processor, causes the processor to:
receive a voltage feedback from a point of common coupling; and
output a signal to regulate q-axis current orders of an inverter.

17. The non-transitory computer-readable medium of claim 16, having further instructions stored thereon that, when executed by the processor, cause the processor to high-pass filter the voltage feedback from the point of common coupling, wherein the high-pass filtering configured is to attenuate low-frequency oscillations.

18. The non-transitory computer-readable medium of claim 16, having further instructions stored thereon that, when executed by the processor, cause the processor to control a q-axis current of the inverter.

19. The non-transitory computer-readable medium of claim 16, having further instructions stored thereon that, when executed by the processor, cause the processor to perform coordinated reactive current control of the inverter.

20. The non-transitory computer-readable medium of claim 16, wherein the inverter is configured as a grid-following inverter.
